(19) United States
(12) Patent Application Publication
(10) Pub. No.: US 2009/0248669 A1
(43) Pub. Date: Oct. 1, 2009

(54) METHOD AND SYSTEM FOR ORGANIZING INFORMATION

(76) Inventors: Nitin Mangesh Shetti, Woodbridge, NJ (US); Alan Levin, Vancouver (CA); Abhishek Mehrotra, North Brunswick, NJ (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/060,778

(22) Filed: Apr. 1, 2008

(51) Int. Cl. G06F 7/00

(52) U.S. Cl. 707/5

(57) ABSTRACT

A system and method to process data having a module stored on the server computer system for receiving a query over a network from a client computer system. A search engine utilizes the query to extract a search result from a data source. A query decomposition module decomposes the query into at least one n-gram which is a subset of the query. A processing module processes the at least one n-gram to determine at least one related search suggestion. A merging module merges the at least one related search suggestion into a ranked output data set. A transmission module transmits the search result and the at least one related search suggestion from the server computer system to the client computer system.

### CROSS-REFERENCE TO RELATED APPLICATIONS

This application is related to U.S. patent application Ser. No. 10/853,552 entitled “METHODS AND SYSTEMS FOR CONCEPTUALLY ORGANIZING AND PRESENTING INFORMATION,” by Curtis, et al., filed on May 24, 2004, which is hereby incorporated herein by reference.

### BACKGROUND OF THE INVENTION

1). Field of the Invention

Embodiments of this invention relate to a data processing system and method that provides improved search data.

2). Discussion of Related Art

The internet is a global network of computer systems and has become a ubiquitous tool for finding information regarding news, businesses, events, media, etc. in specific geographic areas. A user can interact with the internet through a user interface that is typically stored on a server computer system.

Because of the vast amounts of information available on the Internet, users often enter search queries into a search box for processing by a server computer system. The server computer system typically searches a database of information to extract information to provide for the user. Unfortunately, a large amount of information is often provided to the user which can result in the user being overwhelmed. A server computer system can provide search suggestions for refining the search space.

There can be queries for which there are too few or irrelevant results and it is difficult for the user to reword his query to get the right results, hence, this method is useful.

### SUMMARY OF THE INVENTION

The invention provides a method of data processing including receiving a query and utilizing the query to produce at least one related search suggestion from a data source.

The method of data processing may further include decomposing the query into at least one n-gram which is a subset of the query and processing the at least one n-gram to determine at least one related search suggestion.

The method may further include merging the at least one related search suggestion into a ranked output data set and transmitting the at least one related search suggestion.

The method may further include providing at least one n-gram that is at least a uni-gram, bi-gram, tri-gram or greater.

The method may further include processing of the at least one n-gram to identify at least one of an address, a name, an entity, a word overlap, and a stop-word.

The method may further include processing of the at least one n-gram and comparing at least one valid word from the query with at least one valid word from the n-gram to ensure quality.

The method may further include processing of the at least one n-gram and referring to a database containing data related to associations between n-grams and the at least one related search suggestion.

The method may further include merging and assigning the at least one related search suggestion a first score based on a local score, global score, number of words in the n-gram, and number of words in the query. The local score is the strength of association between n-gram and the related search suggestion. The global score is the strength of the n-gram.

The method may further include merging and assigning the at least one related search suggestion a second score measuring the special properties like entity status of the n-gram which lead to that suggestion.

The method may further include filtering the ranked output data set by comparing the at least one related search suggestion with the query and a higher ranked search suggestion having a higher second score than the at least one related search suggestion.

The method may further include filtering the ranked output data set by separating the ranked output data set into at least one of a narrow category, an expand category, and a names category.

The method may further include wherein the transmitting of the at least one related search suggestion is without categorization.

The method may further include filtering of the at least one related search suggestion including at least one category.

In the method, the filtering may include identifying an important phrase containing an important word within the query to categorize the at least one related search suggestion.

The method may further include the important phrase or word being determined by a ratio between a query word with a lowest web frequency and a query word with a second lowest web frequency.

The method may further include processing the at least one n-gram to determine at least one data result and merging the at least one data result into a ranked output data set.

The method may also further include transmitting a final data set based on the ranked output data set.

The method may further include a data source of n-gram-webpage association generated from query -webpage association.

The method may further include filtering the ranked output data set includes filtering by at least one of block list filtering, name extraction filtering, and channel type filtering.

The invention also provides a system for processing data including a server computer system, a receiving module stored on the server computer system for receiving a query over a network from a client computer system.

The system for processing data may further include a search engine that utilizes the query to extract at least one search result from a data source.

The system may further include a query decomposition module to decompose the query into at least one n-gram which is a subset of the query and a processing module to process the at least one n-gram to determine at least one related search suggestion.

The system may further include a merging module to merge the at least one related search suggestion into a ranked output data set and a transmission module to transmit the search result and the at least one related search suggestion from the server computer system to the client computer system.

The invention also provides a system that may further include a query decomposition module to decompose the query into at least one n-gram which is a subset of the query and a processing module to process the at least one n-gram to determine at least one data result.

The system may further include a merging module to merge the at least one data result into a ranked output data set and a filtering module to filter the ranked output data set to create a final data set.

The system may further include a transmissions module to transmit information from the server computer system to the client computer system, the final data set being used to create the transmitted information. The invention also provides machine-readable storage medium that provides executable instructions which, when executed by a computer system, causes the computer system to perform a method including receiving a query.

In the machine-readable storage medium, the computer system may execute the method further including decomposing the query into at least one n-gram which is a subset of the query.

In the machine-readable storage medium, the computer system may execute the method further including processing the at least one n-gram to determine at least one related search suggestion.

In the machine-readable storage medium, the computer system may execute the method further including merging the at least one related search suggestion into a ranked output data set and transmitting the at least one related search suggestion.

The invention also provides machine-readable storage medium that provides executable instructions which, when executed by a computer system, causes the computer system to perform a method including receiving a query.

In the machine-readable storage medium, the computer system may execute the method further including decomposing the query into at least one n-gram which is a subset of the query and processing the at least one n-gram to determine at least one data result.

In the machine-readable storage medium, the computer system may execute the method further including merging the at least one data result into a ranked output data set and transmitting a final data set based on the ranked output data set.

In the machine-readable storage medium, the computer system may execute the method further including transmitting information from the server computer system to the client computer system, the final data set being used to create the transmitted information.

### BRIEF DESCRIPTION OF THE DRAWINGS

The invention is further described by way of example with reference to the accompanying drawings, wherein:

FIG. 1 is a block diagram illustrating a data processing system;

FIG. 2 is a block diagram illustrating a data processing method;

FIG. 3 is a flowchart illustrating how a query is decomposed to produce suggestions;

FIG. 4 is a block diagram illustrating an example of n-grams;

FIG. 5 is a flowchart illustrating a search suggestion filtering process;

FIG. 6 is a flowchart illustrating a suggestion categorization process;

FIG. 7 is a flowchart illustrating how an important word is identified;

FIG. 8 is a screenshot showing a view wherein suggestions are displayed;

FIG. 9 is a block diagram of a network environment in which a user interface according to an embodiment of the invention may find application;

FIG. 10 is a flowchart illustrating how the network environment is used to search and find information; and

FIG. 11 is a block diagram of a client computer system forming area of the network environment, but may also be a block diagram of a computer in a server computer system forming area of the network environment.

### DETAILED DESCRIPTION OF THE INVENTION

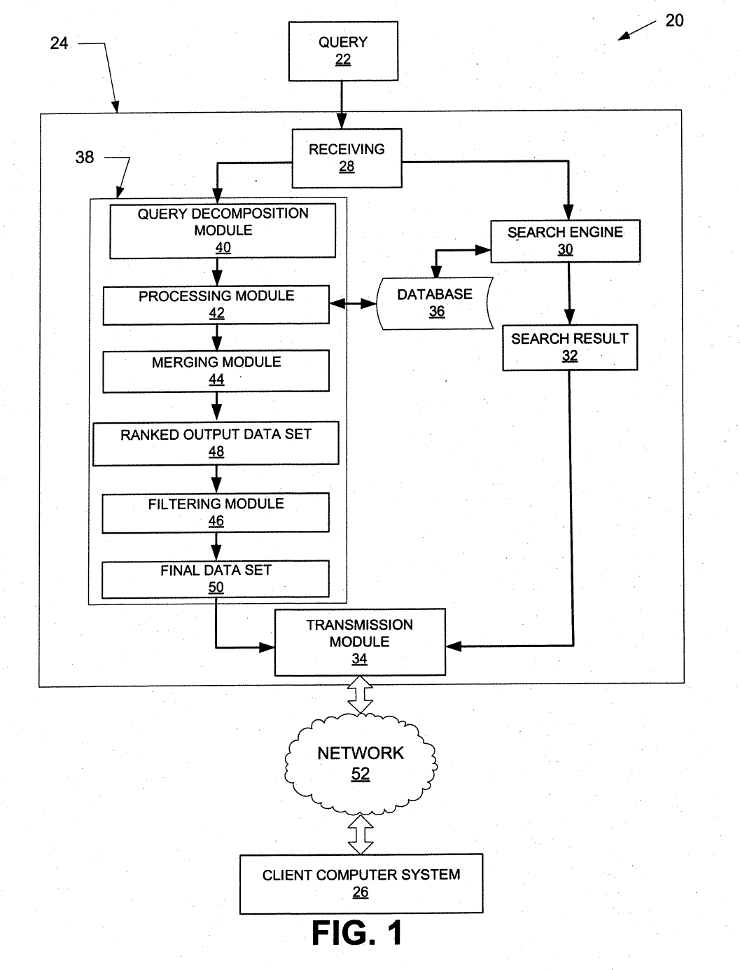

FIG. 1 of the accompanying drawings illustrates a data processing system 20 that includes a query 22, a server computer system 24, and a client computer system 26.

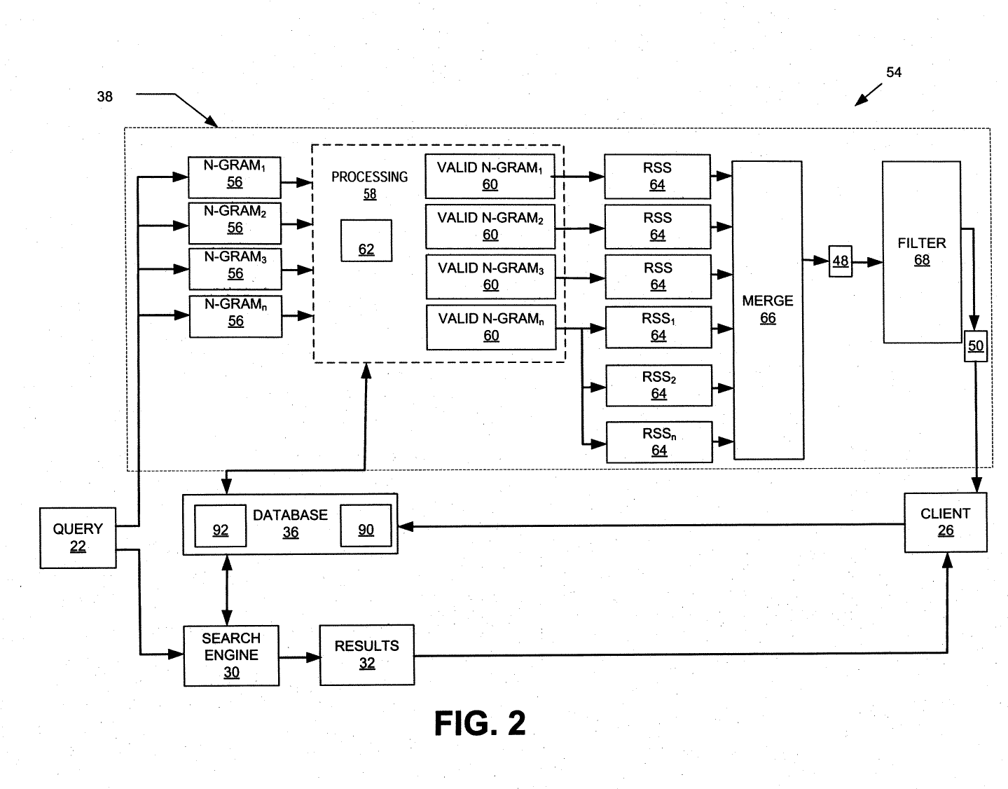

The data processing system 20 is first described with respect to FIGS. 1 and 2, where after its functioning is described.

FIG. 1 shows an initial query 22 that can be received by a receiving module 28 connected with the server computer system 24. The initial query 22 is a general input and can be a search query received from a user of the search engine. However, the initial query 22 may not necessarily be a search query but can be words extracted or crawled from a web document or stored document. The initial query 22 can also be a list of topics related to a search query or any list of characters or words requiring data processing. In addition, the query can come from elsewhere in the data processing system 20, not necessarily originating from the user.

A search engine 30 generating search results 32 is connected with a transmission module 34 which communicates with a plurality of client computer systems 26 over a network 52 where search results 32 can be displayed or communicated to enable user interaction with the search results 32. Search results 32 can be generated by the search engine 30 through referencing a database 36 or any data source. The data source can be any device capable of storing information. The search engine 30 is located on the server computer system 24 but can be located on a remote computer system. The search engine 30 can be of the type found in U.S. application Ser. No. 10/853,552, the contents of which are hereby incorporated by reference.

An initial query 22 is transmitted from the receiving module 28 to a related search suggestion engine 38. The related search suggestion engine 38 contains a query decomposition module 40, a processing module 42, a merging module 44, and a filtering module 46. The merging module 44 creates a ranked output data set 48 which is received by the filtering module 46 and results in a final data set 50. The final data set 50 is received by the transmission module 34 and is transmitted to a client computer system 26 from the server computer system 24. The query 22 can be processed through the search engine 30 and related search suggestion engine 38 simultaneously or in sequence, one after the other. Also, the transmission module 34 may transmit search results 32 and the final data set 50 simultaneously or in a staggered manner through a network 52 to a client computer system 26.

The data base 36 is in communication with both the search engine 30 and processing module 42. It is appreciated that the database 36 can be multiple data sources located on the server computer system 24 or at a remote location.

FIG. 2 illustrates a data processing method 54 that includes an initial query 22, a search engine 30, a related search suggestion engine 38, and a database 36.

FIG. 2 shows the initial query 22 being received by the search engine 30 and the related search suggestion engine 38. The search engine 30 communicates with the database 36 to output search results 32 that are received by a client computer system 26 as previously mentioned.

The related search suggestion engine 38 receives the initial query 22 and decomposes the query 22 into its “components” called n-grams 56 or constituent terms. The n-grams 56 are processed by a processing module 58.

The n-grams 56 are processed 58 into valid n-grams 60 and invalid n-grams 62. The valid n-grams 60 generate related search suggestions 64 (RSS). A related search suggestion 64 is defined as text that is produced and presented to a user so that when the user clicks on the text, a query is processed by a search engine to produce search results. Multiple related search suggestions 64 are generated for each valid n-gram 60; however, it is also possible to generate only one search suggestion 64 per valid n-gram 60.The related search suggestions 64 are merged in a merging process 66 by a merging module 44. The merging process 66 results in a ranked output data set 48 which are filtered through a filtering process 68 by the filtering module 46. The filtering process 68 results in a final data set 50. Thus, the final data set 50 is received by the client computer system 26.

When a search suggestion 64 is selected by a user or client computer system 26, specific information related to the user selection is sent to the database 36. The specific information can contain data concerning which search suggestion the user selected and what n-grams 56 (of the initial query 22) are associated with that selection. Other specific information can be sent to the database 36, such as number of words in the n-gram 56, number of words in the initial query 22, and number of suggestions needed.

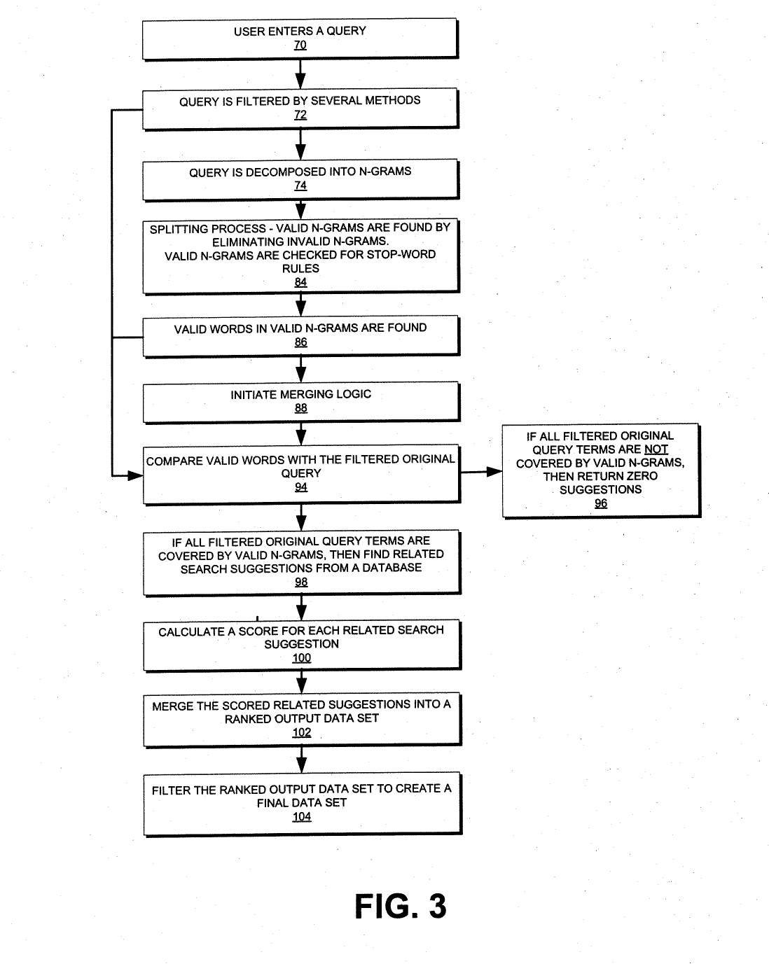

In use, FIG. 3 illustrates a flow diagram of the data processing method 54. FIG. 3 shows a user entering an initial query 22 in a first step 70. The initial query 22 can optionally be initially filtered in a second step 72 by removing double quotes and removing side operator words such as: “Encyclopedia, Weather, Dictionary, site:, lang:, thesaurus:, Bcite:, movies:, define:, definition:, intitle:, stocks:, and InUrl:”. Furthermore, other letter combinations such as “\www., \com\ .com\ .edu\ .gov/ .co.uk\ \ co\uk\” can be eliminated because creating related search suggestions 64 for URLs may not be useful to the user and might provide erratic results. The query 22 is converted into a normalized query format. Normalization can include converting character combinations into other character combinations or removing them altogether. An auto-correction list can also be provided to correct misspellings within the initial query 22. In general, different types of queries 22 can receive different types of filters such as a normal, adult, or non-adult filters. In addition, if an initial query 22 is a taboo phrase found on a taboo list, no n-grams 56 will be generated. Taboo queries can also be identified if the taboo query contains both a word from a first taboo list and a word from a second taboo list. All taboo queries that are identified will not generate n-grams 56 and subsequently will not generate related search suggestions 64. Any customized list of taboo queries can be generated and applied in filtering a query 22. An example of how to define a taboo query, according to an embodiment, is shown below:
Query is defined as taboo if the following conditions hold:
i. Condition 1
   Contains a word from child list or a word from animal list AND
   Contains a word from sex list OR body part list OR porn bucket OR
ii. Condition 2
   Has a phrase from the taboo list

After the initial filtering process 72, the initial query 22 or modified query (if a spelling correction etc. has occurred) can be decomposed into a series of n-grams 56 or constituent terms in a decomposition process 74. Each n-gram 56, according to an embodiment, can be a unigram 76, a bi-gram 78, or a tri-gram 80. However, it is possible to create n-grams 56 containing up to the number of words in an initial/modified query 22. N-grams 56 are a subset of the initial query 22.

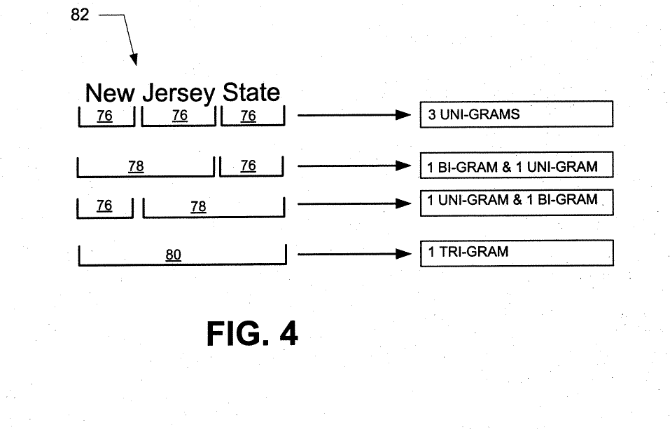

FIG. 4 illustrates an example, according to an embodiment, containing the example query 82 “New Jersey State”. “New Jersey State” can be decomposed into three unigrams 76 being “New”, Jersey”, and “State”. However, the example query 82 can also be decomposed into a bi-gram 78 containing “New Jersey” and unigram 76 containing “State”. The same example query 82 could also be decomposed into a unigram 76 containing “New” and a bi-gram 78 containing “Jersey State”. Finally, the example query 82 could be decomposed as a single tri-gram 80 containing “New Jersey State”.

The bi-grams 78 and tri-grams 80, according to an embodiment, require all words in the n-gram to be directly adjacent to one another to form the n-gram 56 and are filtered to exclude certain prefixes or stop-words. However, it would be possible to create n-grams 56 by skipping words. For example, referring to FIG. 4, the bi-gram 78 “New State” could be formed by skipping the word “Jersey”. Also, according to another embodiment, it would be possible to create n-grams 56 containing more words beyond a tri-gram 80 which only contains three words. Any relationship can be created between n-grams 56 based on common occurrences together within a query 22.

Components or n-grams 56 can contain any or all of the initial query 22 terms, and may optionally be altered for spelling, punctuation, stemming, capitalization, rephrasing, and other standard-text processing manipulations.

The above decomposition is performed by the query decomposition module 40 although it is appreciated that the decomposition can occur in separate modules.

### Splitting Process

FIG. 3 further shows a splitting process 84 where n-grams 56 are processed into valid n-grams 60 and invalid n-grams 62. Valid n-grams 60 are generally defined as n-grams 56 that will provide relevant suggestions 64 without providing too much irrelevant information. The presence of large amounts of irrelevant information will dilute the effectiveness of the search suggestions. An n-gram 56 will be eliminated as being an invalid n-gram 62 if the n-gram 56 is a stop-word, such as “the, and, or, etc.”, which can be located on a “stop-word list” or data set. Stop-words generally produce too much irrelevant information and therefore are eliminated. A tri-gram 80 or bi-gram 78 would also be eliminated if it consisted of only stop-words.

Also, n-grams 56 that are prefixes phrases are eliminated, such as a query 22 containing the words, “Where can I find . . . ”. A prefix list of phrases is provided to filter excessive words that may dilute the effectiveness of finding a search suggestion. Unigram 76 numbers can be eliminated from the processing step 58. For example, the n-gram “100 years” would require the n-gram “100” to be eliminated. The preceding examples are included only for illustration; the inclusion or exclusion of specific n-grams can be controlled by modifying configuration files to allow customized behavior for different applications.

Names are generally defined as proper nouns associated with a person and are identified by a “Names list” or data set. The Names list could also be expanded to include names of places and things as well as persons. Entities are defined on an “Entities list” or data set and include non-name words having special significance or meaning. Entities having special significance will be given a weighted score, as will be later described in more detail. Entities can also include words with no special significance but having highly common group occurrences. For instance, the word “Acura Legend” would be considered an entity, with a weighted score, since it has special significance to a specific type of car. However, the words “abnormal growth” would be considered an entity as well, even though it has no special significance. The words “abnormal” and “growth” have a highly common group occurrence and therefore are considered an entity by association. However, entities with no special significance, such as “abnormal growth”, are not weighted in the scoring of suggestions, as will be later described. In another embodiment, names and entities can be identified algorithmically using entity extraction algorithms well known in the art, or by a combination of algorithms and lists.

### Word Overlap

If an n-gram 56 has a word overlap with another larger n-gram 56 which is an entity or name, the n-gram 56 will be eliminated. Any n-grams 56 that split apart names or entities are eliminated.

An example of n-gram 56 overlapping with a larger n-gram 56 that is a name or entity would be a query 22 containing the bi-gram “Britney Spears”. The unigram “Spears” is related to a certain type of weapon. The name “Britney Spears” occurs on the “Names list” because she is recognized as a famous pop singer. Because the unigram “Spears” has word overlap with the larger bi-gram “Britney Spears”, “Spears” is identified as being an invalid n-gram 62 and is not used to obtain related search suggestions 64. The above example illustrates one way in which valid n-grams 60 are distinguished from invalid n-grams 62.

Word overlap with another n-gram, that is an entity or name, can be determined, according to an embodiment, through implementing the following logic:

Consider a query: X0 X1 . . . X(N−1)

First dummy words, A, B, and C, D are padded before and after the query to form:

A B X0 X1 . . . X(N−1) C D

The various n-grams 56 needed for evaluation from the query are:
X0 X1
X1
X0 X1 X2
X1 X2
X2
X1 X2 X3
X2 X3
X3
. . .
X(N−3) X(N−2) X(N−1)
X(N−2) X(N−1)
X(N−1)

However, the n-grams can be written in a regular pattern as follows:
0) A B X0
1) B X0
2) X0
3) B X0 X1
4) X0 X1
5) X1
6) X0 X1 X2
7) X1X2
8) X2
. . .
(N−1)*3) X(N−3) X(N−2) X(N−1)
(N−1)*3+1) X(N−2) X(N−1)
(N−1)*3+2) X(N−1)
(N*3) X(N−2) X(N−1) C
(N*3+1) X(N−1) C
(N*3+2) C
((N+1)*3) X(N−1) C D
((N+1)*3+1) C D
((N+1)*3+2)D

The n-grams containing dummy words are not going to be used as valid n-grams 60. However, the following pattern emerges:
a) All unigrams get an index %3==2
b) All bi-grams get an index %3==1
c) All tri-grams get an index %3==0
d) The last word in a unigram, bi-gram, or tri-gram can be found by dividing index by 3
e) A unigram with index i shares tokens with n-grams with indices i−2, i−1, i+1, i+2, i+4
f) A bi-gram with index i shares tokens with n-grams with indices i−4, i−3, i−2, i−1, i+1, i+2, i+3, i+5
g) A tri-gram with index i shares tokens with n-grams with indices i−6, i−3, i−2, i−1, i+1, i+2, i+3, i+4, i+6

If an n-gram is a dummy, it cannot be an entity or name. The dummy n-grams are needed so that invalid values are not returned for any of the indices mentioned in e)-f) for n-grams 0, 1, 3 and any n-gram above number of words*3−1.

### Address N-Grams

Another type of n-gram 56 that is analyzed in the splitting process 84 is an address suffix n-gram. Address suffixes, such as “Ave., Pl., Ct., St., Rd., etc.” can be provided on a list or data set for identification in the splitting process 84. An address suffix n-gram, according to an embodiment of the invention, is eliminated if it is recognized as an ambiguous search within the context of the query 22. For example, if a street suffix is present in the query 22 as follows, “V W X Y Z<suffix>M N”, then the following n-gram 56 combinations would be eliminated because street names would get separated from city-state combinations leading to ambiguity in results.
1. <suffix> M
2. <suffix> M N
3. Z
4. Y Z
5. X Y Z
6. Y

Ambiguous n-gram 56 combinations to be invalidated, involving address suffixes, can be stored in a data set or list for reference during the splitting process 84. Also, ambiguous n-gram combinations having an address suffix and a direction n-gram, such as North, N, East, E etc., can be eliminated by reference to a data set or list. For example, referring to the same example query, “V W X Y Z <suffix> M N”, if X is a direction n-gram, then the following n-gram 56 combinations are eliminated as invalid:
1. Y Z <suffix>
2. Z <suffix>
3. WX
4. VWX

Similarly, using the same example query above, if Y is a direction n-gram, the following known ambiguous combinations would be eliminated or invalidated:
1. Z <suffix>
2. XY
3. WXY

It is appreciated that the same type of ambiguous n-gram combination filtering can be applied beyond street suffixes in other contexts.

N-grams 56 recognized as cities, states, or street names, when compared with a city, state, or street name list, can also be analyzed for valid 60 or invalid n-grams 62. If a city and state n-gram is greater than three words, in an embodiment of the invention, the city and state are split into a combination of unigrams 76, bi-grams 78, and tri-grams 80.

However, if an n-gram 56 is recognized as a city and the adjacent n-gram 56 is recognized as a state, and the combined city and state n-gram is less than three words (a tri-gram 80 or less), the city and state n-gram is not split and is marked as an address entity. If the address entity is not part of a larger entity it will become a valid n-gram 60 and will not be eliminated. Therefore, city and state n-gram combinations less than three words may survive the splitting process 84 and can become valid n-grams 60 which generate search suggestions.

Also, street names would not be separated from city names if they occur adjacent to one another in a query 22 within the tri-gram 80 limit. Splitting the street name from the city name would return erratic search suggestions containing a similar street name in an entirely unrelated city. Therefore, maintaining the n-gram containing the street and city is advantageous because it tends to provide more relevant search suggestions.

Address and Name/Entity Conflict

A situation can occur where the address rules and the Names and Entities lists conflict. Conflicts may occur when an address rule determines an n-gram 56 is invalid 62 but the Entity or Names list determines the n-gram 56 is a valid n-gram 60. Naturally, a conflict may also occur when an address rule determines an n-gram 56 is valid 60 but the Entities or Names list determines the n-gram 56 is invalid 62. The general rule applied in these situations is that entities cannot break higher entities which can be defined by the processing module 42. For example, the query 22 “fred thomas edison new jersey” can be parsed into three n-gram 56 combinations:
1) “fred thomas” and “edison new jersey”, or
2) “fred thomas edison” and “new jersey”, or
3) “fred ” and “thomas edison” and “new jersey”.

If there is a conflict between address entities and name entities, according to an embodiment, both entities will survive and neither will be eliminated. Therefore, “fred thomas edison” will not be eliminated and “edison new Jersey” will not be eliminated even though there is a conflict between the two n-grams.

However, the address rules, according to another embodiment, can allow Names or Entities to be dominant over one another. Address entities can be made take precedent over the Names and Entities list so that the association between “thomas” and “edison” will be broken therefore resulting in the first n-gram 56 combination (listed above) being selected as containing the correct valid n-grams 60. It should be noted that “fred thomas edison” occurs on the Names list but was in conflict with the higher address entity of “edison new jersey”. Because “edison new jersey” can be considered a higher entity, it takes precedent over the Names and Entities list. It is appreciated that, in another embodiment, the Names and Entities list could be defined as a higher entity in the processing module 42 and therefore take priority over address entities. Upon determining all invalid n-grams 62, the remaining valid n-grams 60 can be established in the process 86.

Stop-Word Checking

FIG. 3 further shows stop-word checking 84 for valid n-grams 60. Once valid n-grams 60 are established, the adjacent n-grams remaining in the query 22 must be identified as a stop-word, if such a stop-word is present. There are two distinct methods of processing valid bi-grams 78 and unigrams 76 having a stop-word that is adjacent to it.

With respect to a bi-gram 78, if a stop-word is within the valid bi-gram 78, any tri-grams 80 containing the bi-gram 78 must be checked for data. Suppose there is a query 22 containing the elements ABCD. If a valid bi-gram (BC) exists where C is the non-stop-word, then B must be checked to determine whether it is a stop-word. If B is a stop-word, then any tri-grams 80 containing BC must be examined to determine if the tri-gram 80 contains valid data. The tri-grams 80 to be examined in this example are ABC and BCD because they are tri-grams 80 containing the bi-gram BC. If either tri-gram 80 contains related search suggestion data 90 and is a valid tri-gram 80, then the data associated with the bi-gram BC will not be used. The above processing assumes that tri-grams 80 would have higher resolution in finding relevant data and provides the advantage of returning more relevant search suggestions.

For example, suppose a query 22 is entered containing, “if the car is black then”. Suppose that “is black” is identified as a valid bi-gram 78. Assume “black” is a non-stop-word and “is” is identified as a stop-word. Therefore, the tri-grams “car is black” and “is black then” are examined to determine if they contain data. If the tri-grams do contain related search suggestion data 90, such data will be preferred over other data associated with the bi-gram “is black”. Essentially, this processing implements a reverse logic, in that the existence of search suggestion data 90 must be determined to decide which n-grams are valid.

With respect to a valid unigram 76, if a stop-word is adjacent to the unigram 76 (either preceding or succeeding), then the bi-grams 78 containing the stop-word and unigram 76 will be checked for data. For example, suppose there is a query 22 containing the elements BCD. If a valid unigram C exists, then B and D must be evaluated to determine whether they are stop-words because they precede and succeed the unigram C, respectively. If B is a stop-word, then the bi-gram BC will be examined to determine if it contains related search suggestion data 90. If D is a stop-word, then the bi-gram CD will be examined to determine if it contains related search suggestion data 90. If either bi-gram, BC or CD, contains data, then that bi-gram 78 is valid and the relevant search suggestion data 90 will be selected over the unigram, C.

Essentially, for every valid unigram 76 or bi-gram 78, the n-grams 56 containing the valid unigram 76 or bi-gram 78 must be checked for data and will be preferred if data exists. The process of stop-word checking described above can occur in the splitting process 84 according to an embodiment. It is appreciated that the stop-word checking process can occur in a separate process as well. Furthermore, a list of dependent n-grams (resulting from stop-word checking) can be compiled to determine what n-grams should be used in creating related search suggestions 64. In an example, according to an embodiment, stop-word checking can be accomplished by the following logic:
For every valid ngram, find the list of other ngrams to check for stopword word rules. Rules are as follows:
1. If exists an ngram:<stop1><nonstop><stop2> then eliminate ngrams:<stop1><nonstop> and <nonstop><stop2>
2. If exists an ngram:<nonstop><stop1><stop2> then eliminate ngram:<nonstop><stop1>
3. If exists an ngram:<stop1><stop2><nonstop> then eliminate ngram:<stop2><nonstop>
4. If exists an ngram:<stop1><nonstop1><nonstop2> then eliminate ngram:<stop1><nonstop1>
5. If exists an ngram:<nonstop1><nonstop2><stop> then eliminate ngram:<nonstop2><stop>
6. If exists an ngram: <nonstop1><stop1><nonstop2> then eliminate ngram:<nonstop1><stop1>,<stop1><nonstop2>
7. If exists an ngram:<stop1><nonstop> then eliminate ngram:<nonstop>
8. If exists an ngram:<nonstop><stop1> then eliminate ngram: <nonstop>
These rules can be rewritten as:
a)<stop1><nonstop> depends on the following:
   a.<stop1><nonstop><stop2>
   b. <stop1′><stop1><nonstop>
   c. <stop1><nonstop><nonstop2>
   d. <nonstop1><stop1><nonstop>
   i.e. <stop1><nonstop> is preceded or succeeded by other words which form valid tri-grams
   For bi-gram i (BC), we need to first check if B is a stopword. This can be done by checking the unigram i−2 (B).
   For bi-gram i (BC), next we need to check the tri-grams ABC and BCD to see if they are valid. These are given by i−1 and i+2 respectively.
b) <nonstop><stop2> depends on:
   a. <stop1><nonstop><stop2>
   b. <nonstop><stop2><stop2′>
   c. <nonstop1><nostop2><stop2>
   d. <nonstop1><stop2><nonstop2>
   i.e. <nonstop><stop2> is preceded or succeeded by other words which for valid tri-grams
   For bi-gram i(BC), we need to first check if C is a stopword. This is done by checking i+1.
   For bi-gram i(BC), next we need to check if ABC and BCD are valid.
      This is done by checking i−1 and i+2.
c) <nonstop> depends on:
   a. <stop1><nonstop>
   b. <nonstop><stop1>
   i.e. <nonstop> is preceded or succeeded by a stopword
   For unigram i(C), we need to first check if B preceding C or D succeeding C is a stopword. This can be done by checking i−3 and i+3.
   For unigrami(C), if B or C turn out to be stopwords, we need to first check i(BC(i−1) or CD(i+2) are valid respectively.
Merging all rules a, b, and c, we would get:
   a) If ngram is a bi-gram, check i−2 and i+1 to determine if any of the words are stopwords. If there are stopwords, check i−1 and i+2 respectively to see if those tri-grams are valid. Note the valid tri-grams.
   b) If ngram is a unigram, check i−3 and i+3 to determine if preceding and succeeding words are stopwords. If any of the words are stopwords, check i−1(if i−3 is a stopword) or check i+2(if i+3 is a stopword). If the bi-grams are valid, those would be noted.
   Make sure that the rules DO NOT CASCADE.

### Valid Words

FIG. 3 further shows valid words being determined 86. After valid n-grams 60 are determined, valid words must be found in each valid n-gram 60. Valid words can be stored in a list, index, or other known form of data storage. In addition, valid words can be determined algorithmically. According to an embodiment, all stop-words, prefixes, and numbers are eliminated from an initial query 22 unless the query is part of a larger entity. For unigrams 76, all stop-words and numbers are eliminated except if the unigram 76 is part of an entity, located on the Names or Entity list. With respect to bi-grams 78 with index i (where i+1 and i−2 are the unigrams), an array is kept of all non-stop-words and non-number words except if the word is part of a larger entity. For valid tri-grams 80 with index i (ABC), where i+2 (C), i−1 (B) and i−4(A) are valid unigrams 76, stop-words or numbers are eliminated unless they are a part of a larger entity. It should be noted that only important entities and names are used for retaining valid words. The important entities and names can be identified in the Names and Entities list or index. Valid words will be stored and utilized in an initial query check 94, later described. In an example, according to an embodiment, finding valid words can be accomplished by the following logic:
a) For initial query, check all words i.e. i %3==2. stop-words prefixes and numbers are eliminated, except if they are part of a larger entity.
b) For unigrams, stopwords and numbers are eliminated, except if the uni-gram is part of an entity
c) For bi-grams with index i, i+1 and i−2 are the unigrams, keep an array of all non-stopword and non-numbers words except if word is part of larger entity.
d) For valid tri-grams with index i (ABC), i+2(C), i−1(B) and i−4(A) are valid unigrams. If they are stopwords or numbers, they are not kept in the list except if the word is part of larger entity. Only important entities/names are used for retaining valid words.

### Merging Logic

FIG. 3 shows a merging logic initiation process 88. The processing module 42 can access the database 36 upon determining a set of valid n-grams 60. The related suggestion data 90 and n-gram data 92 are searched and return related search suggestions 64. The n-gram to suggestion data 90,92 is acquired and may be calculated based on query-to-query data gathered by a search engine as described in U.S. application Ser. No. 10/853,552, herein incorporated by reference. To implement the merging logic initiation process 88, the n-gram to suggestion data 90,92 is required. The database 36 contains suggestion data 90 and its correlation to n-gram data 92. The merging module 44 implements the merging process 66 where shorter n-grams are eliminated if longer valid n-grams 60 exists that contain suggestion data 90.

For entities, names, the address rule, and the stop word rule, if a longer valid n-gram 60 contains any search suggestion data 90, the shorter n-gram within the longer n-gram 60 will be eliminated as a source of search suggestion data 90. Generally, longer n-grams are more likely to be rare queries and often contain less data than shorter non-rare n-grams. Shorter n-grams tend to be more popular queries and may return large amounts of irrelevant data.

### Initial Query Check

FIG. 3 shows an initial query check 94. Once valid n-grams 60 are identified and merged 88, and valid words have been determined 86, a comparison process 94 compares the valid words from the initial query 22 (minus stopwords, numbers, and prefixes) and the valid words from the valid n-grams 60 to ensure that all words in the initial query 22 are present in the union of words in the valid n-grams 60. If the filtered initial query 22 terms are not covered or represented by valid words, then zero suggestions should be returned 96. The initial query check 94 occurs to ensure that all initial query 22 terms are considered in creating related search suggestions 64. Also, because certain n-grams don't have results, each valid n-gram 60 must be checked to ensure that n-gram data 92 exists.

In an example, according to an embodiment, initial query comparison 94 can be accomplished by the following logic:
a) Iterate over all ngrams with data and put the valid words in a set
b) Put all words for the ngram==initial query and put in another set
c) Find set difference between b minus a. This should be empty. If it is NOT empty, no suggestions should be returned.

FIG. 3 further shows a suggestion generating process 98 where the valid n-grams 60 are processed 58 by accessing the database 36 having data concerning suggestion data 90 and any related n-gram data 92. In one embodiment, related suggestion data 90 is created by collecting queries issued by a plurality of users in a session along with an initial base query 22. The related suggestion data 90 and its correlation to n-gram data 92 are stored in the database 36. The related suggestion data 90 is associated with one or more n-grams 92 through indexing, meta-tag headers containing n-grams 56, or any conceivable method of association. The database 36 generates a list of related search suggestions 64 based on the valid n-grams 60 received.

Intra-session scoring can also be applied to n-gram 60 to suggestion data 90 indexing. In intra-session scoring, queries further away from the original query in a session are weighted lower. Also, instead of keeping the raw form of data from the sessions for related queries, the query can be normalized and hashed and kept in that form. A separate hash to raw form can be maintained.

### Suggestion Scoring

FIG. 3 shows a scoring process 100 that can be initiated by the merging module 44. In addition, we can detect if a session consists of a majority of crossword puzzle/trivia questions and remove such sessions from participating in the scoring process. The scoring process 100 calculates a score component for each related search suggestion 64 generated by the database 36. Initially, the following equation is applied:

$$Score [ suggestion ] = 1 - ( \frac{local\_score}{global\_score} \times \frac{no . \_of \_words \_in \_ngram}{no\_of \_words \_in \_original \_query} )$$

The above equation calculates an individual score for each n-gram using a local score which is a number representative of how many users asked a suggestion query in a session, with queries containing a specific n-gram. The global score is based on the n-gram itself. The global score represents the number of users asking all the queries that gave rise to an n-gram. The product of individual Score[suggestion] values for n-grams create a total score for the suggestion as a whole.

The local and global scoring can be defined, in an embodiment, according to the following logic:
N-gram data is generated as follows:
Note: n(X)→number of words in n-gram/query X
1) Consider Q2Q data where Q1 is associated with Q2, with a certain score S12. Q1 also has global score of S1. Let n(Qi) be number of words in a query Qi.
2) Q1 is split into various n-grams and Q2 is associated with all of these n-grams of Q1. For n-gram n1, the association with Q2 will have a local score of S12*n(n1)/n(Q1). Also, global score of n1 would be S1*n(n1)/n(Q1).
3) Later, n1 could have come from various queries, so the global score of n2 would be a sum of all these partial global scores i.e. Σ (Si*n(n1)/n(Qi)) over all queries Qi that n1 is derived from.
4) Local score for n1−Q2 would be Σ (Si2*n(n1)/n(Qi)) over all queries Qi which n1 derived from and Qj which was associated with Qi.

If an n-gram is too popular, the result of Score[suggestion] is a larger score which is less desired in the above equation. The local-to-global ratio is adjusted by being multiplied with a second ratio equal to the number of words in an n-gram divided by the number of words in the initial query 22.

Based on the above Score[suggestion] equation, a lower Score[suggestion] ratio indicates a highly desired score. The following score is used in merging the suggestions for all valid n-grams 62 to form a ranked output data set 48:

$$Actual\_ratio = n ( 1 - ( 1 - \frac{e}{n} ) \times Product\_over \_all \_ngrams ( Score [ Suggestion ] ) )$$

The above equation includes the weighted scores for entities, as previously described. The equation is defined by the variables e and n. The variable e represents a score related to the number of entities and name n-grams from the initial query 22 which contributed to the suggestion being scored. The variable n represents the total number of n-grams from the initial query 22. The expression

$$( 1 - \frac{e}{n} )$$

gives weight to the suggestions that came from entities or names as defined on the Entities and Names list. The scoring evaluates the entity or name contributions. It should be noted that the Actual_ratio value is calculated by subtracting Score[suggestion] from a value of one. Therefore, a higher Actual_ratio value is more desired and indicates a higher ranked suggestion. However, as previously mentioned, entities with no special significance having highly common group occurrences (such as “abnormal growth”) are not considered in the above scoring equation and are not given weight.

If there is a tie in scoring between two suggestions using the Actual_ratio score, a tie breaker between two Actual_ratio scores is determined by the equation:

Tie _breaker=1−Product_over _all _ngrams(Score[Suggestion])

The tie breaker equation utilizes the Score[suggestion] value subtracted from a value of one, so that a higher tie breaker score is desired in winning a tie breaker. It should be noted that the Score[suggestion] value excludes any contributions from entities or names as described above and is based purely on the local score, global score, and number of words in the query 22 and n-gram. If a query is an entity,

$$( 1 - \frac{e}{n} )$$

is zero, hence all suggestions get an actual ratio score of 1, which is not useful. Therefore a tiebreaker is needed. Thus, the possibility of having a tie within the Score[suggestion] value is less likely than having a tie within the Actual_ratio score.

FIG. 3 further shows a merging and final ranking process 102. The suggestions are merged together based on the n-grams that lead to them and scored to produce a ranked output data set 48. The ranked output data set 48 is filtered 104 as described below.

### Suggestion Filtering

The ranked output data set 48 is received by the filtering module 46. The filtering module 46 filters the ranked output data set 48 in a suggestion filtering process 104 and outputs a final data set 50.

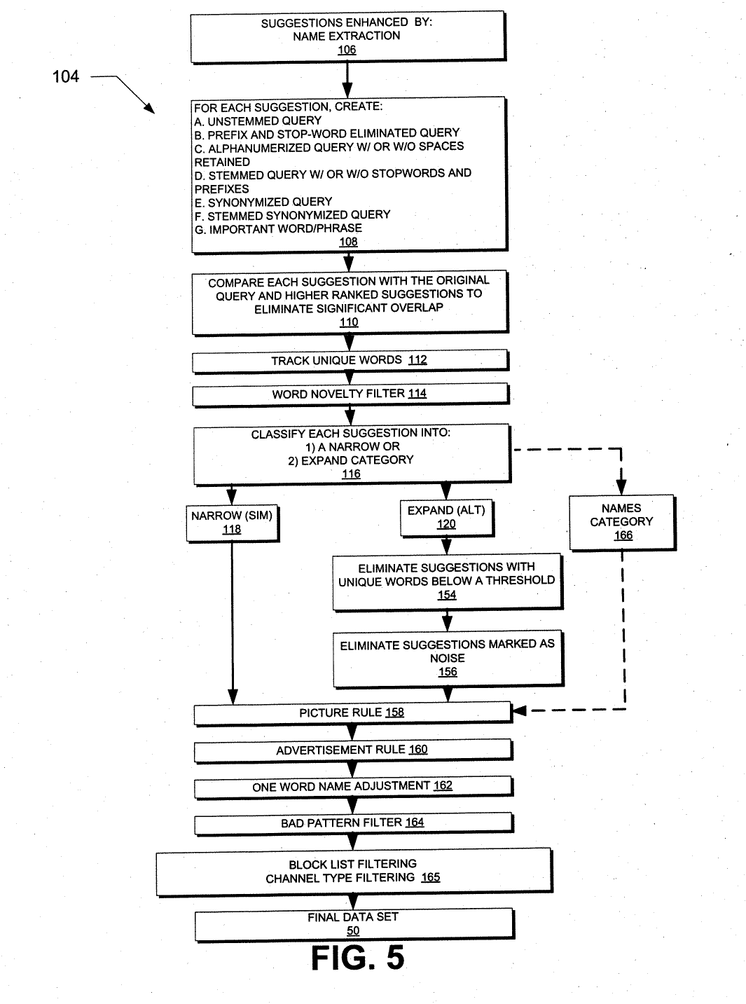

FIG. 5 illustrates the suggestion filtering process 104 where the ranked output data set 48 is initially enhanced by a name extraction process 106. The objectives of the filtering process 104 are to eliminate duplicate suggestions and to provide the appropriate suggestion based on a user's channel.

A name extraction enhancement process is possible by extracting names from related search suggestion data 90 and adding the names to the Related Names-category as related search suggestions 64. A related search suggestion 64 would receive a final ranking score, i. Names that are derived from related search suggestions 64 get the same score as the original suggestion. Of course, it can be additive if other suggestions give rise to that name or the name suggestions already exists. If the name comes from multiple suggestions or itself, the scores are added up and resorted. It is possible to extract one word names or block one word names from being extracted.

FIG. 5 further shows a filtering process 108, where for each suggestion, the following is created: an unstemmed query; a prefix and stop-word eliminated query; an alpha-numerized query (all characters other than alphabets and numbers are removed); an alpha-numerized query with spaces retained; a stemmed query without stopword and prefix elimination; a stemmed query with stopwords and prefixes eliminated; a synonymized query (certain words are replaced by a root synonym word); a stemmed synonymized query; and an important word or phrase. The results for each suggestion are used to implement the processes further described below.

FIG. 5 also shows the suggestions being filtered through suggestion overlap filtering 110 and unique word tracking 112. The purpose of these filters is to eliminate repeated suggestions and maintain unique results. In the suggestion overlap filter process 110, every related search suggestion 64 is compared with the initial query 22 and any search suggestions having a higher ranking score. For each related search suggestion 64, determine the suggestion or initial query 22 with which the related search suggestion 64 has the highest overlap in order to eliminate suggestions that are repetitive or exactly the same. The suggestion or initial query 22 with the highest overlap is considered the maximum overlap partner. The maximum overlap partner is determined by obtaining the following information in comparing each and every suggestion with the initial query 22 and suggestions with higher rank:
a. result overlap;
b. strings exactly match after stemming and synonym normalization (overlap of 1)[stemmed synonymized form];
c. strings exactly match after prefix/stopword removal (overlap of 1)[stopword and prefix eliminated query];
d. strings exactly match after alphanumerization (overlap of 1) [alphanumerized form].

It should be noted that edit distance can also be used as a factor in determining overlap between suggestions. The above information is utilized to calculate an overlap score between 0 and 1. The result overlap score can be calculated, in an embodiment, according to the following logic:
a. For top 20 URLs of a query, calculate cosine similariy on a usercount.
b. Let Q1 and Q2 be two queries with the following URLs:
Q1: U1(n11), U2(n12), U3(n13) . . . Uk(n1k), P1(m11), P2m12) . . . Pj(m1j)
Q2: U1(n21), U2(n22), U3(n23) . . . Uk(n2k), R1(o21), R2(o22) . . . Re(o2e)
Note that U1 . . . Uk are URLs common between Q1 and Q2.
Cosine similarity is defined as:
(Σₖ(n1k*n2k))/(sqrt((Σₖ(n1k*n1k)+Σⱼ(m1j*m1j))*(Σₖ(n2k*n2k)+Σₑ(o2e*o2e)))))

If a related search suggestion 64 has a maximum overlap greater than 0.9 with another suggestion or initial query 22, it is eliminated because it is too similar to the maximum overlap partner. Also, if the related search suggestion 64 has a synonym in common with the maximum overlap partner and the maximum overlap is greater than 0.45 (0.9/2), the related search suggestion 64 is eliminated.

During the unique word tracking and filtering process 112, unique words are tracked and stored in a location to be referenced to ensure that queries contain unique words. Unique words are defined as words that are not stop-words. In the following filtering process 114, a word novelty filter eliminates suggestions that do not have a unique word. For example, suppose there are four suggestion, A, B, C, and D ranked in order from one to four, respectively. The word novelty filtering process 112 would ensure that suggestion D contains a unique word that does not occur in suggestions ABC. If suggestion D does not contain a unique word (compared to ABC), it is eliminated.

### Suggestion Categorization

FIG. 5 further shows the filtering process 116 where related search suggestions 64 are categorized into a “Narrow Your Search” category 118 (Narrow—similar) or an “Expand Your Search” category 120 (Expand—alternative). A third “Related Names” category 166 could also be created, according to another embodiment, which lists related names to a query 22. Any known method of names categorization can be used if a Related Names category is created.

The Narrow category 118 provides the user with the related search suggestions 64 similar to the initial query 22. A suggestion located in the Narrow category 118 can be referred to as a “SIM”. The Expand category 120 enables the user to search alternative queries that may provide desired results beyond the scope of the initial query 22. A suggestion located in the Expand category 120 can be referred to as an “ALT”. It is understood that multiple categories beyond Narrow, Expand, and Names categories can be created related to the n-gram.

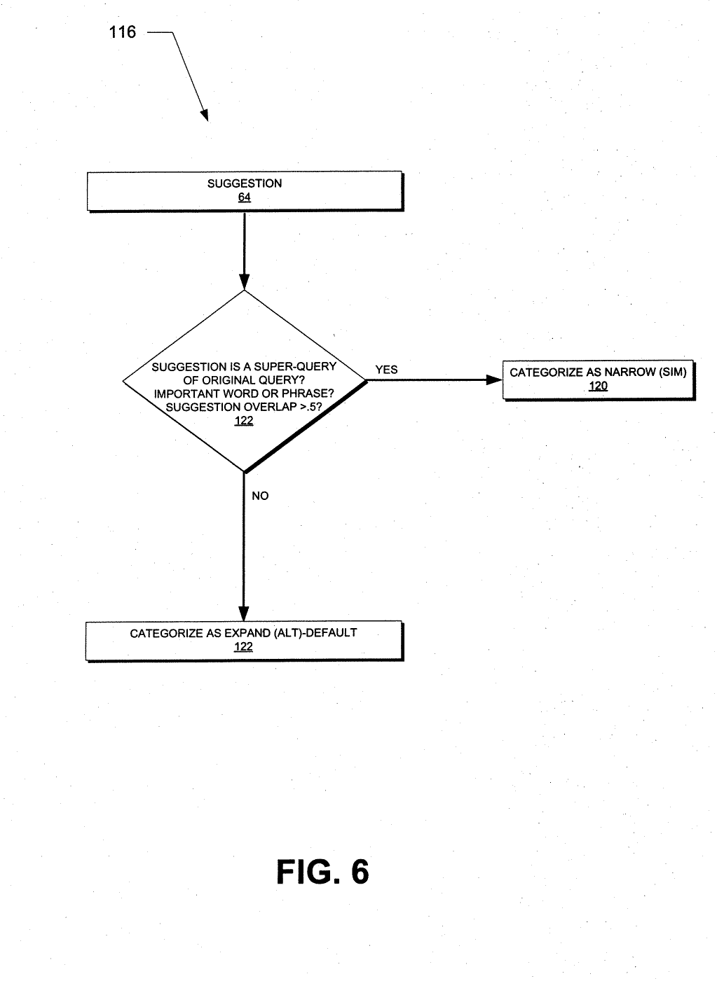

FIG. 6 illustrates the classification step 116 having a decision process 122 which analyzes whether a related search suggestion 64 is categorized into Narrow 118 or Expand 120. If a related search suggestion 64 is a super-query of an initial query 22, it is categorized in the Narrow category 118. A super-query is a query that contains the initial query 22 but is longer than the initial query 22. Furthermore, a related search suggestion 64 is categorized in the Narrow category 118 if it has significant result overlap greater than 0.5 with another SIM or suggestion within the Narrow category. Unlike, the maximum overlap values previously discussed, there is no need for a suggestion to be a maximum overlap partner with another SIM for this categorization process. All suggestions not categorized in the Narrow category 118 are categorized in the Expand category 120 by default. Finally, a related search suggestion 64 is also categorized in the Narrow category 118 if it contains an important word or phrase.

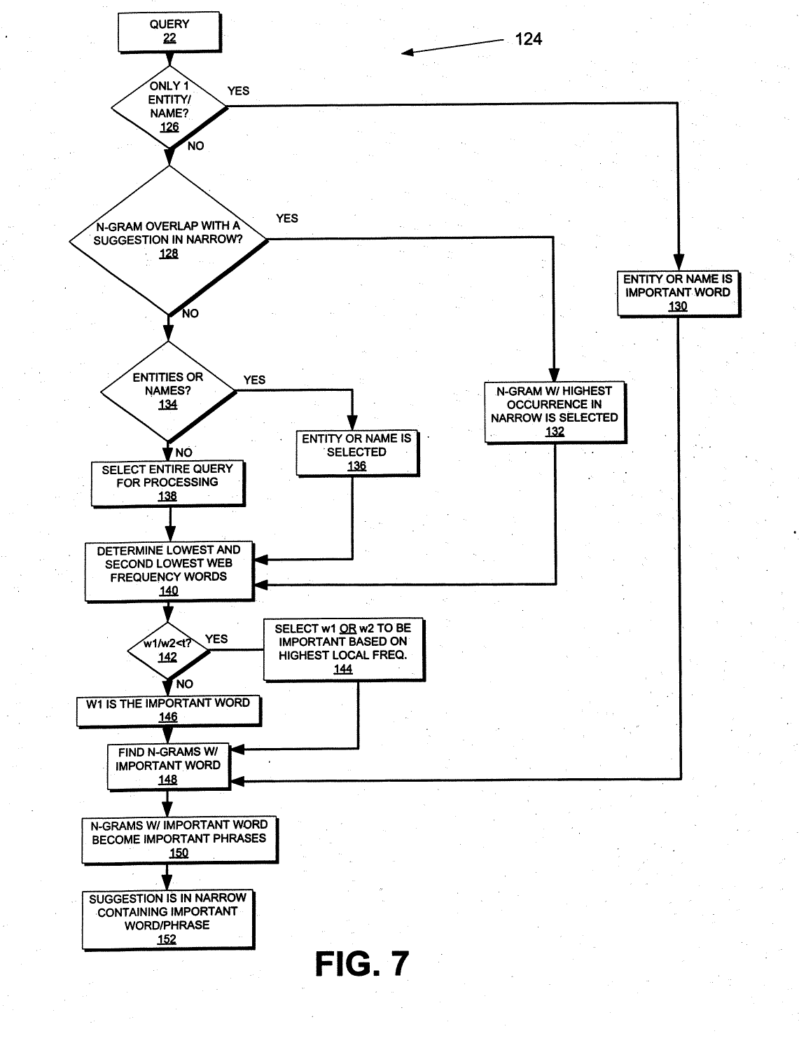

FIG. 7 illustrates the process 124 for determining an important word or phrase within a query 22. If there is just one entity or name among all n-grams of a query 22, then it becomes the important word or phrase in the initial process 126, 130, because it is given higher weight than other words. If there are multiple entities or names within a query 22, the important word must be determined by selecting a parsing query as shown in the following overlap process 128. If there is n-gram overlap between the query 22 and one or more SIMS in the Narrow category 118, as previously defined, then the n-grams that occur with the highest frequency within the Narrow category 118 become selected as a parsing query, as shown in process 132. If no overlap is found with a SIM in the Narrow category 118, then any names or entities are selected 134,136 as the parsing query. If no names or entities exist in the step 134, then the entire query 22 is selected as a parsing query. The process of checking for n-gram overlap 128 with SIMS provides the advantage of shortening the search phase for an important word since the entire query 22 does not have to be selected for processing and thus provides an advantage in decreased processing time. In contrast, selecting an entire query 22 for processing would be disadvantageous in that it would increase the processing time of the search phase.

For example, suppose a query 22 was entered such as “Where can I find information on Britney Spears and Tom Cruise?”. Because there is more than one name or entity (2 names) within the query 22, the important word must be determined through an n-gram comparison with suggestions existing in the Narrow category 118. If the name “Britney Spears” occurs in the Narrow category 118 three times, and the name “Tom Cruise” only occurs once, then “Britney Spears” will be flagged as the parsing query where the important word can be found.

However, if no data exists in the Narrow category 118, the next process 134 selects the name or entity n-grams as the parsing query. Therefore, in our example, “Britney Spears” and “Tom Cruise” would have been selected as the parsing query to find the important word because both n-grams likely occur on the Names list.

However, if “Britney Spears” and “Tom Cruise” are not found on the Names list or in the Narrow category, then the entire query 22 must be selected 138 as a parsing query for further processing.

After a parsing query is selected 132, 136, 138 for processing, the web frequencies of all words within the parsing query are determined. The lowest (W1) and second lowest (W2)web frequency words are then determined 140. The lowest, W1, and second lowest, W2, web frequency words are compared 142 in a frequency ratio against a predetermined threshold (t):

$$\frac{w 1}{w 2} 〈 t$$

The predetermined threshold t can be any number defined by the filtering module 46, such as the number four, for example. The variable w1 is the web frequency of the lowest web frequency word, W1, and the variable w2 is the web frequency of the second lowest web frequency word, W2. The frequency ratio (w1/w2) looks to determine if w1 and w2 are within the same order of magnitude. If the frequency ratio is below the predetermined threshold t, then the two words, W1 and W2, are within an order of magnitude and therefore the local frequency of each word must be determined 144. W1 or W2 is selected as the important word by comparing each word's local frequency in suggestion data. The most dominant word prevails which is defined as the word having the highest local frequency within a local suggestion set. The local frequency is the number of suggestions a word occurs in, within a local suggestion set.

However, FIG. 7 further shows that if the frequency ratio w1/w2 is above a predetermined threshold, meaning w1 and w2 are not within an order of magnitude, then W1, the least frequent word, is automatically chosen as the important word, as seen in the process 146. However, it should be noted that it is possible to set a minimum web frequency which any word must meet before becoming an important word.

Once an important word is determined, all n-grams 56 within the initial query 22 containing that word are determined 148 and thus become important phrases, as shown in the process step 150. After the important words and phrases are determined, suggestions containing the important word or phrase will be categorized 152 as SIM in the Narrow category as shown in FIGS. 5 and 6.

For example, suppose the initial query 22, “New Jersey State Flag” is entered. “New Jersey” occurs in the Narrow category 118 already, in the form of suggestions such as “New Jersey Bird” or “New Jersey Flower”. Therefore, the parsing query chosen is “New Jersey” because it has overlap with the other suggestions in the Narrow category 118. The n-grams with the highest occurrence in Narrow are selected as the parsing query. Therefore, “New Jersey” is selected as the n-gram with the highest occurrence since “New Jersey Bird” and “New Jersey Flower” contains the n-gram “New Jersey”. Then the lowest and second lowest web frequency words are determined within the parsing query. “Jersey” has the lowest web frequency because the word “New” is so common it could be considered a stop-word. Therefore, “Jersey” becomes the important word. Thus, the phrases in the initial query 22 containing the important word would be categorized as important phrases. The initial query 22 “New Jersey State Flag” can be broken into three n-grams: 1) “New Jersey” 2) “State Flag” and 3) “New Jersey State Flag”.

Because options 1) and 3) contain the important word “Jersey” they become important phrases. Thus, “New Jersey” and “New Jersey State Flag” become important phrases. Therefore, any related search suggestions 64 containing an important word or phrase become categorized 146 in the Narrow category 118 as a SIM.

FIG. 5 shows all related search suggestions 64 that do not become a SIM will become an ALT suggestion in the Expand category 120. If a unique word occurs in an ALT suggestion and the unique word has an occurrence less than a threshold (such as three), the suggestion is eliminated in the unique word filtering process 154. The unique word filtering process 154 is an exception to the word novelty filter 114, previously described. Requiring a minimum level of unique word occurrences in ALT suggestions, prevents too many random unwanted results from occurring in the Expand category 120.

Also, a noise elimination process 156 will eliminate ALT suggestions that are considered “noise” because they are too popular. The “noise” words can be maintained on a list for reference by the noise elimination process 156.

FIG. 5 further shows a picture elimination process 158 where related search suggestions 64 containing pictures, or the words “picture, pic, photography, photo, etc.” or any other photography related word, is eliminated unless the initial query 22 contains such a word.

Moreover, FIG. 5 shows an advertisement rule 160 where suggestions that are predetermined to be advertising suggestions are eliminated in order for the user to obtain meaningful search suggestions. A list of advertising queries can be created to compare with the search suggestions in order to eliminate advertising suggestions.

FIG. 5 also shows a one word name adjustment process 162 where a contextual check occurs in the search suggestion list to identify one word names and move them to a Related Names category which is displayed to a user. If certain lists have greater than one suggestion associated with it in a suggestion list, then all one word names from the specific list are moved over to the Related Names category. For example, if “Vivaldi”, occurs often in a suggestion set with “Bach” and “Wagner” (recognized as composers on a composer's list), then “Vivaldi” is moved to the Related Names category for user interaction and is therefore is excluded from the Expand category 120. If a name is not recognized or associated with the specific list, it is categorized according to whether the name appears on the general Names list. The one word name adjustment can be accomplished, in an embodiment, according to the following logic:
a) Get all lists for the suggestions and if certain lists have >1 suggestion associated with them, all one word suggestions from that list are classified as Names.

FIG. 5 further shows the bad pattern filter process 164 where all the query data is processed and bad pattern suggestions are identified. For related search suggestions 64 on the image channel, only image flagged suggestions will be returned and will be filtered for bad patterns. First, all the query data is analyzed and queries which triggered the image channel are identified. Secondly, queries with bad patterns are filtered. For instance, if a user enters the query 22 “where can I buy pictures”, searching the query 22 in the image channel would return irregular results. Therefore, patterns (such as the example, “where can I buy pictures”) within the image channel are recognized and suggestions are filtered based on known query phrases that return irregular results in the image channel. In addition, other patterns such as “crossword” or “trivia” patterns can be detected for further filtering from the related suggestion data.

After the bad pattern filter process 164, a block list filtering and channel filtering process 165 can be implemented. A block list can eliminate all related search suggestions 64, eliminate certain suggestions, or replace suggestions with a replacement search suggestion. The block list is loaded by the server computer system 24 which handles the general processing and can find a replacement search suggestion to modify the final data set 50. The block list can be manually created, according to an embodiment of the invention, or the block list may be automatically generated.

Channel filtering is possible by identifying whether a channel is a clean channel or an adult channel in determining what related search suggestions 64 should be modified. For example, if a channel is identified as a clean channel, related search suggestions 64 containing adult content will be invalid. However, if a channel is identified as an adult channel, all suggestions are to be used. It's also possible to channel filter in an image channel.

After the above suggestion filtering process 104 is complete, a final data set 50 of related search suggestions is created and sent to the client computer system 26.

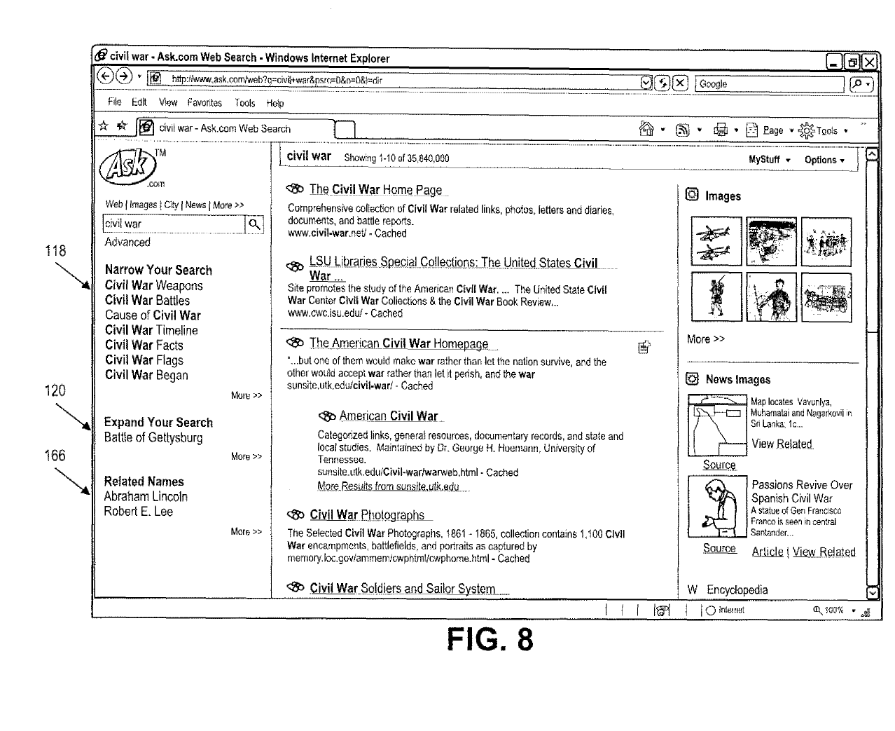

FIG. 8 illustrates an example, according to an embodiment, of how the final data set 50 can be displayed in the Narrow category 118, Expand category 120, and the Related Names category 166 (if one was created).

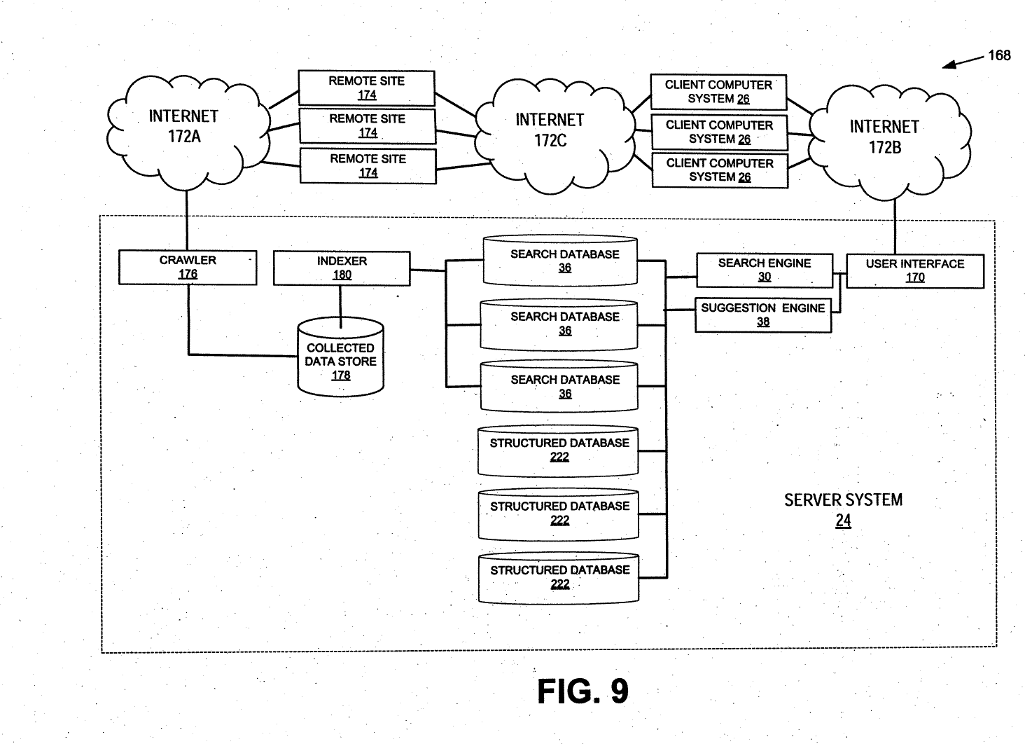

FIG. 9 of the accompanying drawings illustrates a network environment 168 that includes a user interface 170, according to an embodiment of the invention, including the internet 172A, 172B and 172C, a server computer system 24, a plurality of client computer systems 26, and a plurality of remote sites 174.

The server computer system 24 has stored thereon a crawler 176, a collected data store 178, an indexer 180, a plurality of search databases 36, a plurality of structured databases and data sources 222, a search engine 30, a search suggestion engine, 38, and the user interface 170. The novelty of the present invention revolves around the user interface 170, the search engine 30, the search suggestion engine 38, and one or more of the structured databases and data sources 222. The crawler 176 is connected over the internet 172A to the remote sites 174. The collected data store 178 is connected to the crawler 176, and the indexer 180 is connected to the collected data store 178. The search databases 36 are connected to the indexer 180. The search engine 30 and search suggestion engine 38 are connected to the search databases 36 and the structured databases and data sources 222. The client computer systems 26 are located at respective client sites and are connected over the internet 172B and the user interface 170 to the search engine 30 and search suggestion engine 38.

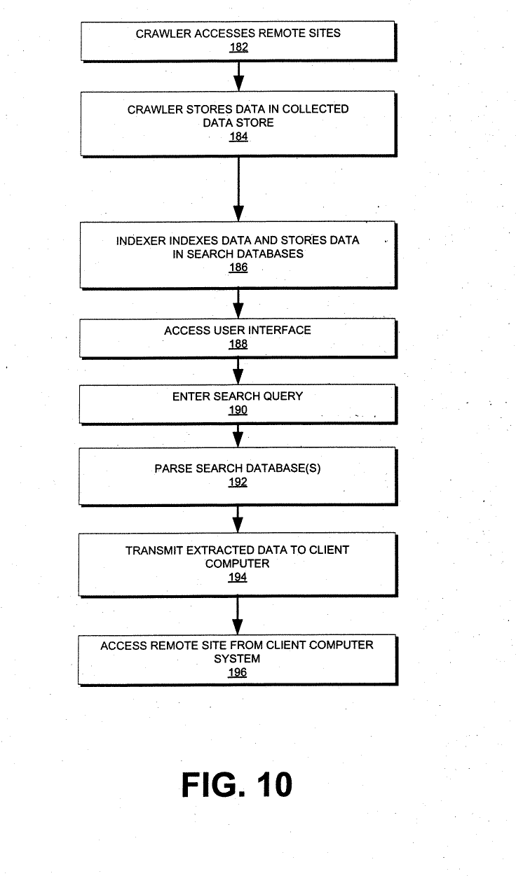

Reference is now made to FIGS. 9 and 10 in combination to describe the functioning of the network environment 168. The crawler 176 periodically accesses the remote sites 174 over the internet 172A (step 182). The crawler 176 collects data from the remote sites 174 and stores the data in the collected data store 178 (step 184). The indexer 180 indexes the data in the collected data store 178 and stores the indexed data in the search databases 36 (step 186). The search databases 36 may, for example, be a “Web” database, a “News” database, a “Blogs & Feeds” database, an “Images” database, etc. The structured databases or data sources 222 are licensed from third party providers and may, for example, include an encyclopedia, a dictionary, maps, a movies database, etc.

A user at one of the client computer systems 26 accesses the user interface 170 over the internet 172B (step 188). The user can enter a search query in a search box in the user interface 170, and either hit “Enter” on a keyboard or select a “Search” button or a “Go” button of the user interface 170 (step 190). The search engine 30 then uses the “Search” query to parse the search databases 36 or the structured databases or data sources 222. In the example of where a “Web” search is conducted, the search engine 30 and suggestion engine 38 parse the search database 36 having general Internet Web data (step 192). Various technologies exist for comparing or using a search query to extract data from databases, as will be understood by a person skilled in the art.

The search engine 30 and suggestion engine 38 then transmit the extracted data over the internet 172B to the client computer system 26 (step 194). The extracted data includes URL links to one or more of the remote sites 174. The user at the client computer system 26 can select one of the links to the remote sites 174 and access the respective remote site 174 over the internet 172C (step 196). The server computer system 24 has thus assisted the user at the respective client computer system 26 to find or select one of the remote sites 174 that have data pertaining to the query entered by the user.

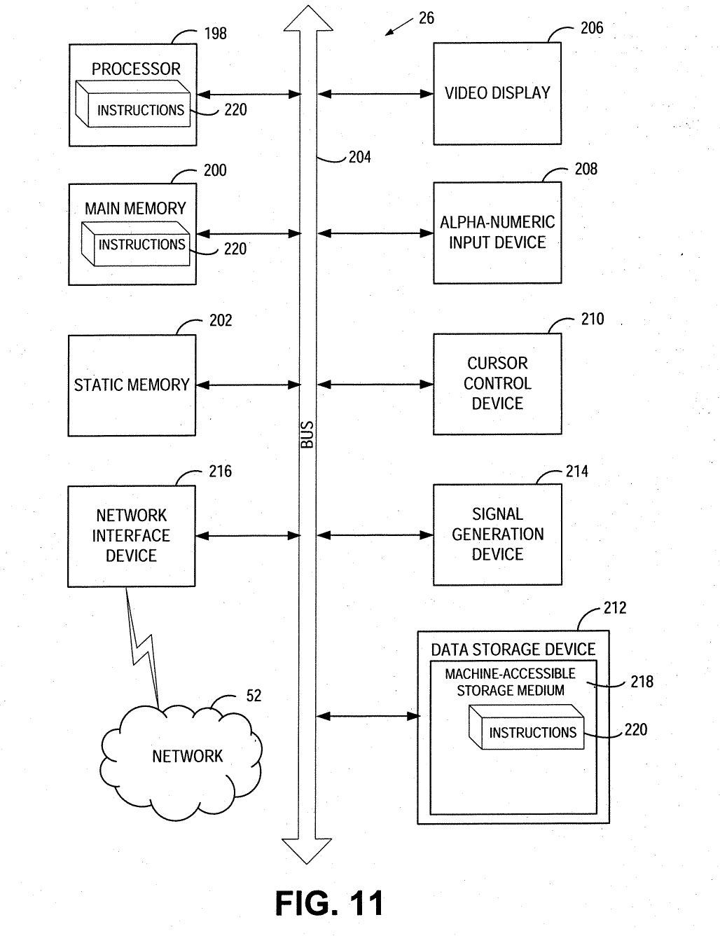

FIG. 11 shows a diagrammatic representation of a machine in the exemplary form of one of the client computer systems 26 within which a set of instructions, for causing the machine to perform any one or more of the methodologies discussed herein, may be executed. In alternative embodiments, the machine operates as a standalone device or may be connected (e.g., network) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term (machine) shall also be taken to include any collection of machines that individually or jointly execute a set (or multiple sets) of instructions to perform any one or more of the methodologies discussed herein. The server computer system 24 of FIG. 9 may also include one or more machines as shown in FIG. 11.

The exemplary client computer system 26 includes a processor 198 (e.g., a central processing unit (CPU), a graphics processing unit (GPU), or both), a main memory 200 (e.g., read-only memory (ROM), flash memory, dynamic random access memory (DRAM) such as synchronous DRAM (SDRAM) or Rambus DRAM (RDRAM), etc.), and a static memory 202 (e.g., flash memory, static random access memory (SRAM), etc.), which communicate with each other via a bus 204.

The client computer system 26 may further include a video display 206 (e.g., a liquid crystal display (LCD) or a cathode ray tube (CRT)). The client computer system 26 also includes an alpha-numeric input device 208 (e.g., a keyboard), a cursor control device 210 (e.g., a mouse), a disk drive unit 212, a signal generation device 214 (e.g., a speaker), and a network interface device 216.

The disk drive unit 212 includes a machine-readable medium 218 on which is stored one or more sets of instructions 220 (e.g., software) embodying any one or more of the methodologies or functions described herein. The software may also reside, completely or at least partially, within the main memory 200 and/or within the processor 198 during execution thereof by the client computer system 26, the memory 200 and the processor 198 also constituting machine readable media. The software may further be transmitted or received over a network 154 via the network interface device 216.

While the instructions 220 are shown in an exemplary embodiment to be on a single medium, the term “machine readable medium” should be taken to understand a single medium or multiple media (e.g., a centralized or distributed database or data source and/or associated caches and servers) that store the one or more sets of instructions. The term “machine readable medium” shall also be taken to include any medium that is capable of storing, encoding, or carrying a set of instructions for execution by the machine and that caused the machine to perform any one or more of the methodologies of the present invention. The term “machine readable medium” shall accordingly be taken to include, but not be limited to, solid-state memories, and optical and magnetic media.

One advantage of the above data processing method 54 and system 20 is that related search suggestions 64 can be offered for new or rare queries. New or rare queries may have less reliable search results and the related search suggestions 64 can create a safer fallback option.

Another advantage is that suggestion coverage may increase dramatically over current methods. A significant share of the search engine page previews can be attributed to clicks on related search suggestions 64, so increased coverage should increase page views.

In addition to increased coverage of queries, this method also increases the average number of suggestions per query, applicable to both rare and non-rare queries. The related search suggestions 64 can drive traffic from non-monetized to monetized queries more easily using the above query decomposition method.

An alternative embodiment could apply the above query decomposition method in a general search result context. For instance, search results from a search engine can be processed in the same manner the related search suggestions 64 were processed. The scoring scheme described herein could be applied to query decomposition of search results.

In another alternative embodiment, the query decomposition method can be applied to any query based system such as creating a classification for queries in a system. Other applications measuring any other kind of affinity, such as user-to-user affinity or pick-to-pick relationships, can be measured using the query decomposition method above. Specifically, common query components could be measured. Moreover, a correlation between all queries and picks in a session could be created using the above decomposition method.

In another alternative embodiment, the data processing method 54 can be accomplished without a filtering step 104. The ranked output data set 102 could be transmitted directly to the client computer system 26 without filtering. Moreover, filtering could occur on the client computer system 26 instead of the server computer system 24. Furthermore, different filtering methods and criteria may be applied to different types of suggestions while remaining within the scope of this invention. For instance, more stringent filters may be applied to the Narrow category 118 than the Expand category 120. Also, the data processing method 54 can create only a Narrow category of suggestions while excluding the Names category 166 and the Expand category 120. Many variations in the types of categories to be displayed to the user are possible. For example, a display of search suggestions without any category is possible. In another example, a display of at least one category is possible.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of data processing comprising:
receiving a query;
decomposing the query into at least one n-gram which is a subset of the query;
processing the at least one n-gram to determine at least one related search suggestion;
merging the at least one related search suggestion into a ranked output data set; and
transmitting the at least one related search suggestion.

2. The method of claim 1, wherein the at least one n-gram is at least a bi-gram.

3. The method of claim 1, wherein the processing of the at least one n-gram includes identifying at least one of an address, a name, an entity, a word overlap, and a stop-word.

4. The method of claim 1, wherein the processing of the at least one n-gram includes comparing at least one valid word from the query with at least one valid word from the n-gram to ensure quality.

5. The method of claim 1, wherein the processing of the at least one n-gram includes referring to a database containing data related to associations between n-grams and the at least one related search suggestion.

6. The method of claim 1, wherein the merging includes assigning the at least one related search suggestion a first score based on a local score, global score, number of words in the n-gram, and number of words in the query.

7. The method of claim 6, wherein the merging includes assigning the at least one related search suggestion a second score measuring an entity contribution to the suggestion.

8. The method of claim 7, further comprising filtering the ranked output data set by comparing the at least one related search suggestion with the query and a higher ranked search suggestion having a higher second score than the at least one related search suggestion.

9. The method of claim 1, further comprising filtering the ranked output data set by separating the ranked output data set into at least one of a narrow category, a names category, and an expand category.

10. The method of claim 1, wherein the transmitting the at least one related search suggestion provides at least one related search suggestion without categorization.

11. The method of claim 1, further comprising filtering the ranked output data set by separating the ranked output data set into at least one category.

12. The method of claim 9, wherein the filtering includes identifying an important phrase containing an important word within the query to categorize the at least one related search suggestion.

13. The method of claim 12, wherein the important word is determined by the web frequency of the words of the query and configured to use the ratio between frequencies of the query word with a lowest web frequency and a query word with the second lowest web frequency.

14. A method of data processing comprising:
receiving a query;
decomposing the query into at least one n-gram which is a subset of the query;
processing the at least one n-gram to determine at least one data result;
merging the at least one data result into a ranked output data set; and
transmitting a final data set based on the ranked output data set.

15. The method of claim 14, wherein a data source of the processing of the at least one n-gram includes an n-gram-to-webpage association generated from a query-to-webpage association.

16. The method of claim 14, wherein the filtering the ranked output data set includes filtering by at least one of block list filtering, name extraction filtering, and channel type filtering.

17. A system for processing data comprising:
a server computer system;
a receiving module stored on the server computer system for receiving a query over a network from a client computer system;
a search engine that utilizes the query to extract at least one search result from a data source;
a query decomposition module to decompose the query into at least one n-gram which is a subset of the query;
a processing module to process the at least one n-gram to determine at least one related search suggestion;
a merging module to merge the at least one related search suggestion into a ranked output data set; and
a transmission module to transmit the search result and the at least one related search suggestion from the server computer system to the client computer system.

18. A system for processing data comprising:
a server computer system;
a receiving module stored on the server computer system for receiving a query from a client computer system over a network at a server computer system;
a query decomposition module to decompose the data input into at least one n-gram which is a subset of the query;
a processing module to process the at least one n-gram to determine at least one data result;
a merging module to merge the at least one data result into a ranked output data set;
a filtering module to filter the ranked output data set to create a final data set; and
a transmissions module to transmit information from the server computer system to the client computer system, the final data set being used to create the transmitted information.

19. A machine-readable storage medium that provides executable instructions which, when executed by a computer system, cause the computer system to perform a method comprising:
receiving a query;
decomposing the query into at least one n-gram which is a subset of the query;
processing the at least one n-gram to determine at least one related search suggestion;
merging the at least one related search suggestion into a ranked output data set; and
transmitting the at least one related search suggestion.

20. A machine-readable storage medium that provides executable instructions which, when executed by a computer system, cause the computer system to perform a method comprising:
receiving a query;
decomposing the query into at least one n-gram which is a subset of the query;
processing the at least one n-gram to determine at least one data result;
merging the at least one data result into a ranked output data set; and
transmitting a final data set based on the ranked output data set.
